(19) United States
(12) Patent Application Publication
(10) Pub. No.: US 2003/0227481 A1
(43) Pub. Date: Dec. 11, 2003

(54) Creating user interfaces using generic tasks

(76) Inventors: Udo Arend, Heidelberg (DE); Edmund Eberleh, St. Leon-Rot (DE); Heinz Willumeit, Leimen (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/289,052

(22) Filed: Nov. 6, 2002

Related U.S. Application Data
(60) Provisional application No. 60/386,320, filed on Jun. 5, 2002.

(51) Int. Cl. G09G 5/00

(52) U.S. Cl. 345/762

(57) ABSTRACT

Creating user interfaces by identifying specific tasks to be carried out by users, matching the specific tasks with generic tasks, and creating the user interface from generic user-interface components associated with the generic tasks. The generic user-interface components are specified with the details of the specific tasks. The generic user-interface components may be assembled in a generic floor plan. The specific and/or generic tasks may be identified by a reverse-engineering process including the analysis of a number of existing user interfaces.

### CROSS-REFERENCE TO RELATED APPLICATIONS

This application claims benefit from U.S. Provisional Application Ser. No. 60/386,320, filed Jun. 5, 2002 and entitled “Methods of Developing Business Processes Using Patterns and Component Tasks,” which is incorporated by reference in its entirety.

### TECHNICAL FIELD

The invention relates to using generic tasks.

### BACKGROUND

Many computer applications use visual user interfaces. A graphical user interface typically consists of a number of controls arranged in a layout for display on a computer screen. The controls are graphic elements associated with the function(s) of the computer application and may include buttons, text entry fields, labels, checkboxes, drop-down menus, etc. The controls provide data input from, and data output to, the user, for example when the user clicks on a button, enters data in a field or reads text in a message box.

User interfaces are typically generated by manual processes. During the development of a computer application, it is frequently determined what specific tasks the user should be able to perform through the user interface. It may then be necessary to identify and obtain suitable controls for the user interface corresponding to the user's tasks. These controls are then assembled into a layout, forming the user interface.

This control-focused generation of user interfaces sometimes has disadvantages. For example, the manual assembly of controls requires time and labor and may therefore impact the efficiency and quality of the project. If several people create user interfaces for related purposes, it may be difficult to maintain a consistent appearance and/or functionality among the user interfaces. Moreover, when creating a new user interface it may not be practicable to draw much benefit from the work spent on assembling controls for an earlier user interface. Because the assembled controls are closely related to the tasks performed by the user, a different user interface may require one to start over with the work of obtaining and assembling the controls.

### SUMMARY

The invention relates to using generic tasks. In a first general aspect, a user interface may be developed by identifying specific tasks to be carried out by users. Each specific task is matched with one among a plurality of generic tasks. The user interface is created by gathering generic user-interface components associated with at least one of the generic tasks. Each generic user-interface component is specified using the specific tasks that are matched with the generic task with which said generic user-interface component is associated.

In selected embodiments, the generic user-interface components may be assembled in a generic floor plan. The generic floor plan may be developed for the gathered generic user-interface components.

In a second general aspect, a user interface may be developed using a reverse-engineering process. A first plurality of specific tasks to be carried out by users is identified. At least one application process is analyzed to determine a second plurality of specific tasks included in the application process. A generic task is determined for each specific task in the second plurality and each generic task is associated with a generic user-interface component. Each task in the first plurality is matched with a generic task. The user interface is created by gathering the generic user-interface components associated with at least one of the generic tasks. The generic user-interface components are specified using the specific tasks.

In selected embodiments, specifying the generic user-interface components includes declaring at least one from the group consisting of a function, a field, a label, and a table of one of the specific tasks.

One feature of the above aspects is that generic tasks may be identified by determining underlying structures, features and/or actions that are common among at least some of the specific tasks.

Advantages of embodiments of the invention may include one or more of the following. Developing user interfaces quicker by avoiding the steps of manually assembling controls into a layout, and by reducing the time needed to determine where in a layout specific controls should be placed. Producing more user-friendly interfaces due to consistency in the places where tasks are performed. Using pre-built user-interface components to save time and improve the consistency in the “look and feel” and the functionality of user interfaces.

### BRIEF DESCRIPTION OF THE DRAWINGS

FIG. 1 is a diagram schematically showing an embodiment of the inventive method;

FIG. 2 schematically shows the mapping of generic component tasks to generic user-interface components;

FIG. 3 is an exemplary floorplan that can be used with the generic user interface components in FIG. 2;

FIG. 4 is an example of a user interface created using the method shown in FIG. 1;

FIG. 5A shows an existing user interface that may be used for identifying specific and generic component tasks;

FIG. 5B shows an example of generic component tasks identified in the user interface shown in FIG. 5A;

FIG. 6A shows another existing user interface that may be used for identifying specific and generic component tasks;

FIG. 6B shows an example of generic component tasks identified in the user interface shown in FIG. 6A;

FIG. 7 shows an exemplary floor plan with subtasks for a generic task of temporarily collecting information; and

FIG. 8 shows an example of a user interface component that may be developed using the floor plan shown in FIG. 7.

Like reference symbols in the various drawings indicate like elements.

### DETAILED DESCRIPTION

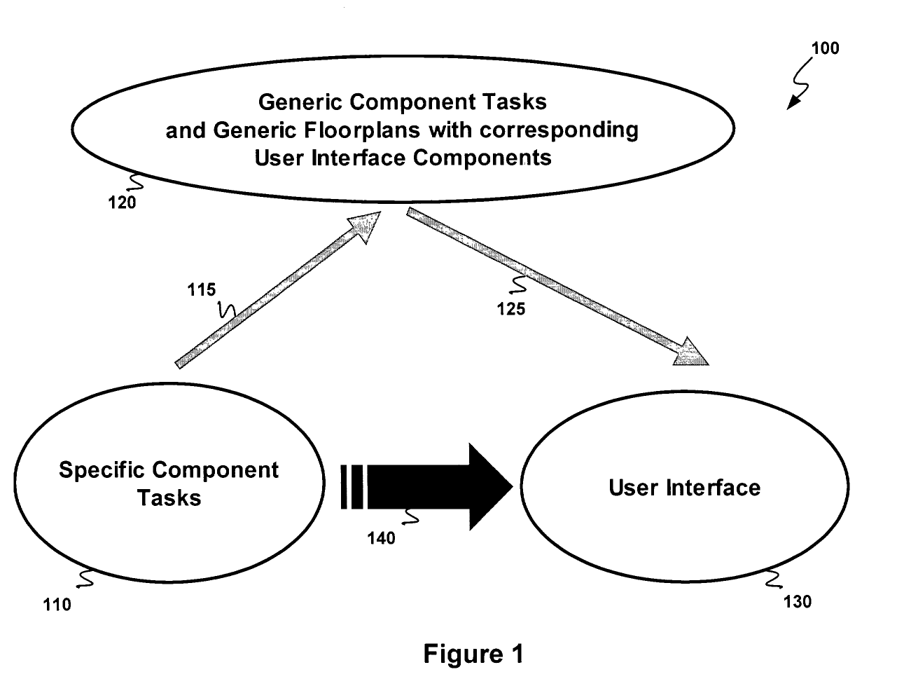

FIG. 1 schematically shows an embodiment of a method of developing user interfaces. It is assumed in this example that the user interface is intended for a particular application which will be embodied in software. The functionality of this software application is referred to as the “business process.” The method in FIG. 1 develops a user interface for a software application that is capable of carrying out the business process.

In short, the method includes identifying specific component tasks (110) of the business process, matching (115) the specific component tasks with generic component tasks and corresponding generic user-interface components (120), assembling (125) the selected generic user interface components in a generic floorplan to form a user interface (130), and specifying the user interface with the details of the specific component tasks (140). The generic component tasks are so named because they are the generic tasks that can be performed using a generic user-interface component. The specific component tasks, then, are the specific tasks that are matched with the generic task of the user-interface component. The above example will now be described in detail.

Reference numeral 110 in FIG. 1 indicates the specific component tasks of the business process. Typically, a specific component task (SCT) can be identified while the business process is being designed. SCTs are coherent activities that a user may carry out for a particular purpose in the business process. Editing an address, searching for an object, and reading the status of an object are all examples of what can be SCTs in a particular business process.

Some typical tasks in the work of a sales associate will be used as a further example of SCTs. In this example, it is assumed that some form of user interface exists, and that the sales associate is using it to operate a software application according to a business process. The sales associate may perform the tasks listed in the following table.

TABLE 1
Specific Component Tasks

Starts the system and checks mail and calendar
Looks for today's activities or critical activities
Selects a single activity for further reading or processing
Checks if the displayed activity is the correct one
Takes a quick look at the status and main data of the activity
Changes some data related to a previous customer contact
Accesses a record of a person related to the activity and updates an address
Reads news items in preparation for contacting the person

It can be seen that the above examples are all coherent activities for particular purposes in the business process, e.g., the acts of selecting, reviewing and editing an activity object. With reference to the above list, it should be noted that SCTs do not depend on the particular control that is ultimately used to trigger the task in a computer. Rather, the SCTs are the activities that are part of the business process, regardless of how the user causes them to be performed.

The SCTs are matched with generic component tasks (120) as indicated by the arrow labeled 115 in FIG. 1. A generic component task (GCT) is a class of coherent activities carried out in business processes. For example, “collecting” is a GCT including the class of all collecting activities in business processes, e.g., collecting products, collecting contacts and collecting calendar items.

GCTs may be defined based on the identified SCTs. This process may be understood as “abstracting” the SCTs into more generic activity concepts, while looking for underlying structures, features and actions that are common among the SCT. For example, after identifying the SCTs of collecting products, contacts and calendar items mentioned above, the GCT “collecting” can be defined because it is common for these SCTs. Another example of defining GCTs involves using existing business processes and will be described later.

The following table matches the SCTs in Table 1 with GCTs.

TABLE 2

| Specific Component Tasks | Generic Component Tasks |
|---|---|
| Starts the system and checks mail | Entering and monitoring |
| and calendar | |
| Looks for today's activities or critical | Selection |
| activities | |
| Chooses a single activity for further | Collection |
| reading or processing | |
| Checks if the displayed activity is the | Orientation |
| correct one | |
| Takes a quick look at the status and | Identification |
| main data of the activity | |
| Changes some data related to a previous | Operation/Extended Operation |
| customer contact | |
| Accesses a record of a person related | Storage/On-Demand |
| to the activity and updates an address | |
| Reads news items in preparation for | Outlet |
| contacting the person | |

The “entering and monitoring” GCT is the class of activities for selecting business processes, for example by choosing to launch an application or access a class of objects. Such activities may be carried out in a portal, where a user may select between alternatives presented as tabs, for example.

“Selection” is the activities of searching for the objects to be worked upon. For example, this GCT may allow the user to enter a query or other search to locate relevant objects. “Collection,” in turn, is the activities of collecting the work objects according to the selection search. In the above example, these two GCTs are performed when the sales associate looks for, say, today's activities and chooses one that is of interest. “Orientation” is the activities of presenting information about the object, often in a read-only format, including its status and navigation information. This GCT may correspond to the sales associate verifying that the displayed activity is the correct one. “Identification” is the class of activities for presenting or viewing the basic data of the selected object. As part of this GCT, data may be displayed in a form.

“Operation” is the activities of presenting and viewing the work object and its constituent data, typically as a main working area. In the above example, this GCT is performed when the sales associate changes data relating to a contact. A related GCT is “extended operation,” which are the activities of presenting and viewing details of the data in the operation GCT. These GCTs do not occur separately in the above example because the data that the sales associate edited was available while performing the operation GCT. Had the sales associate wished to change data at a level of detail that was not available at this stage, however, the extended operation GCT would have been performed to allow editing of the data details.

“Storage/on-demand” is the class of activities of presenting and viewing a separate contained object, typically related to the selected object. When the working object is a product, this GCT may involve viewing an image of the object. In the above example, the sales associate accessed the record of a person related to the selected object.

“Outlet” is the activities of presenting and viewing data of an object related to the working object. In Table 1 above, this GCT was performed when the sales associate viewed a news item related to a contact person. For example, the outlet GCT may involve a separate application displaying information retrieved from any source.

The GCTs are mapped to generic user-interface components. In other words, a generic user-interface component (GUIC) is associated with at least one GCT. The GUICs may be pre-built components that can be assembled when creating the user interface. The GUICs are structures capable of being stored in a suitable readable medium, and that when accessed may be displayed on a screen as part of a user interface. For example, a GUIC may provide technical mechanisms for handling fields, functions, events and tabs.

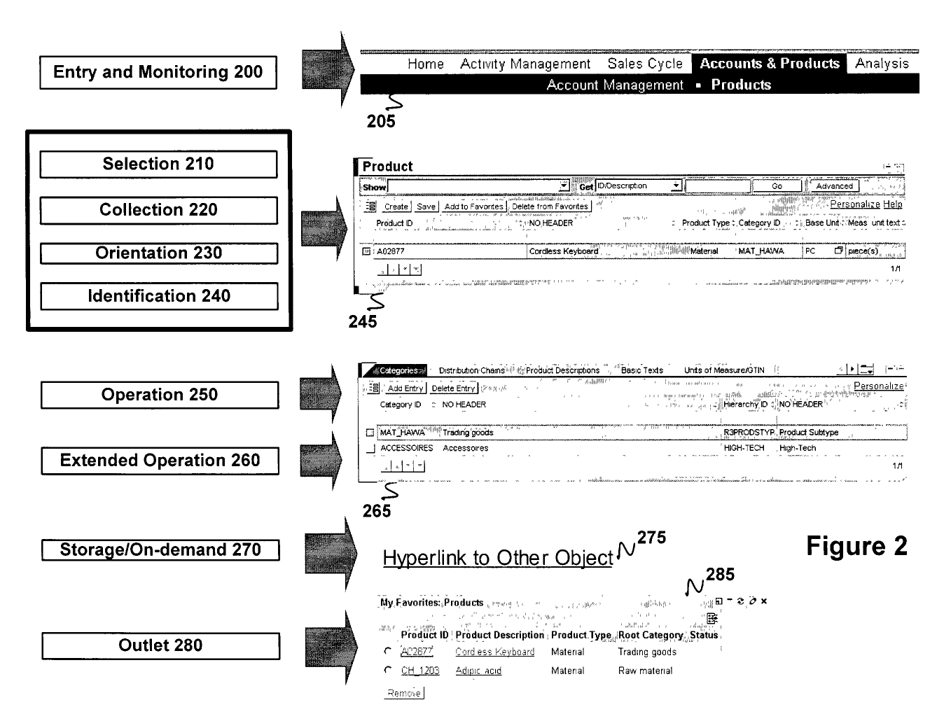

FIG. 2 schematically shows a mapping relationship between GCTs and GUICs. The entry and monitoring GCT 200 is mapped to the GUIC 205, which is a portal. As can be seen, the GUIC 205 allows a user to perform the GCT of choosing which application to launch among “Activity Management,” “Sales Cycle,” and so on. The GUIC may allow sequential choices within the GCT. For example, when the user selects “Accounts & Products,” the GUIC offers the choice between “Account Management” and “Products”.

In this example, GCTs 210, 220, 230 and 240 are mapped to a GUIC 245. Accordingly, the GUIC 245 should cover all activities encompassed by those four GCTs, which includes all SCTs which were matched with the GCTs (FIG. 1).

The GUIC 245 in FIG. 2 is referred to as an object identification container. Examples of such components are described in three pending U.S. patent applications by the current inventors:

MINIMIZATION FUNCTION FOR A COMPUTER USER INTERFACE, Ser. No. 10/231,896, filed Aug. 30, 2002;

TABLE FILTERING IN A COMPUTER USER INTERFACE, Ser. No. 10/233,085, filed Aug. 30, 2002; and

DATABASE ACCESS MECHANISMS FOR A COMPUTER USER INTERFACE, Ser. No. 10/256,968, filed Sep. 27, 2002.

The above three applications, including any application(s) from which they claim priority, are incorporated herein by reference in their entirety.

The GCTs 250 and 260 are each mapped to a GUIC 265. The GUIC 265 should be able to perform all SCTs matched with the GCTs 250 and 260. The GUIC 265 is referred to as an object data container and is described in detail in the first two applications incorporated by reference above. It is sometimes preferable to use more than one GUIC 265 for the GCTs 250 and 260. For example, a first GUIC 265 may perform the activities of the GCT 250, and a second GUIC 265 those of GCT 260.

The storage/on-demand GCT 270 is mapped to a “Hyperlink to Other Object” 275. This GUIC may be a hyperlink such as is used with conventional hypertext markup language (HTML) documents. For example, the GUIC 275 may allow the user to link to a record of a person related to a selected object, as exemplified above.

The GCT 280 is mapped to a GUIC 285 which is an application that displays information. This embodiment uses the “iViews” application from SAP AG in Walldorf, Germany. Different applications could be used in other embodiments, such as a browser application.

The selected GUICs will be assembled to create a user interface. However, merely placing pre-built components randomly in a layout may unnecessarily complicate the user interface and make it difficult to use. Therefore, generic floor plans are developed for the GUICs. The GUICs may be assembled in a generic floor plan manually or by an automated process. For example, a computer on which the GUICs are stored may execute a program for assembling the selected GUICs in a generic floor plan available to the computer.

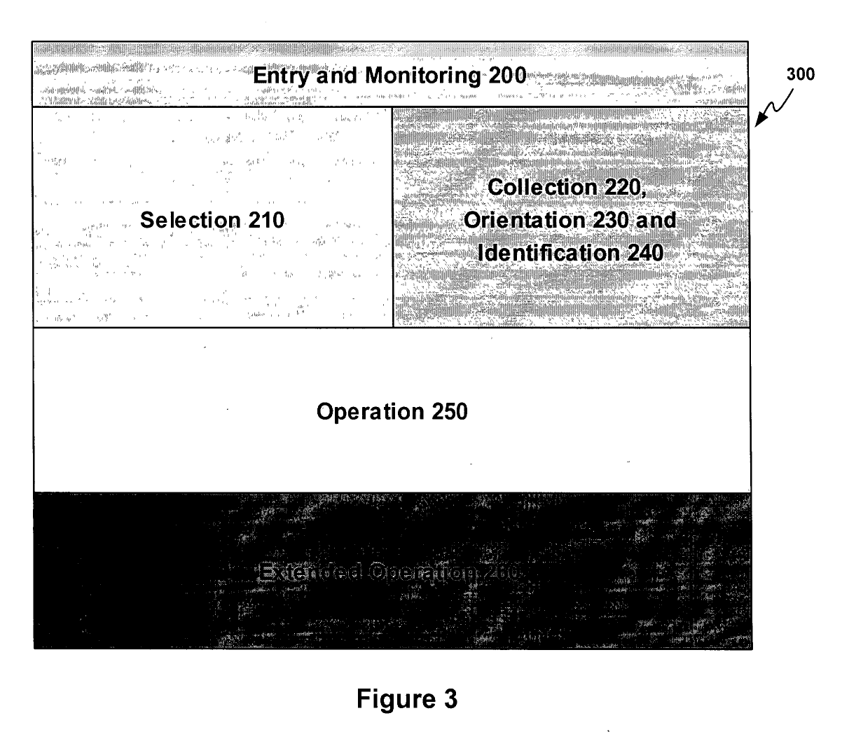

FIG. 3 shows an example of a generic floor plan 300 and the generic area allocation for GUICs corresponding to the GCTs 200-260. The entry and monitoring GCT 200 will be mapped to a GUIC at the top of the floor plan 300. Beneath it, GCTs 210, on one hand, and GCTs 220, 230 and 240, on the other, are shown side by side. This indicates that a user may carry out a selection of objects (by a search), followed by collection, orientation and identification of the objects resulting from the search. These steps may be repeated, for example if an executed search did not produce a satisfactory result, and this may be visualized as going back and forth between the two sets of GCTs. A single GUIC may correspond to the four GCTs 210-240, as is the case with the GUIC 245.

The operation GCT 250 will be mapped to a GUIC below the GUIC(s) corresponding to the GCTs 210-240. Below it, the extended operation GCT 260 will be mapped to another GUIC (which, as noted, may be the same type of GUIC as for the operation GCT 250). The storage/on-demand GCT 270 is not explicitly shown in FIG. 3. The GUIC for this GCT may be a hyperlink included in one of the GUICs, for example in the GUIC corresponding to the operation GCT 250. In some such embodiments, activating the hyperlink causes the display of another object (perhaps related to the currently selected object) in a new floor plan similar to the floor plan 300. The floorplan in FIG. 3 also does not explicitly show the outlet GCT 280. In summary, if the matching of SCTs with GCTs leads to the identification of the GUICs 205, 245, 265 and 275, the generic floor plan 300 may be used to control the arrangement of the identified GUICs in the user interface.

The user interface generated from the GUICs is parameterized with the specifics of the SCTs. This is indicated by the arrow 140 in FIG. 1, and may involve declaring for each GUIC the specific functions, fields, labels, table content, etc. of the corresponding SCTs. A GUIC need not visually exhibit any specific functions or features before it has been parameterized. Rather, it has the capability of being specified to perform said functions. The GUIC 245 in FIG. 2, for example, was created to include the logic for the search functions associated with the “Show,” “Get” and “Advanced” buttons near its top. The parameterization defines the labels that are used in executing the search functions. The functions of the five buttons shown below the search bar, including the labels “Create,” “Save,” etc., and their placements, may also be predefined in the GUIC 245. They are activated to make them functional in the GUIC 254.

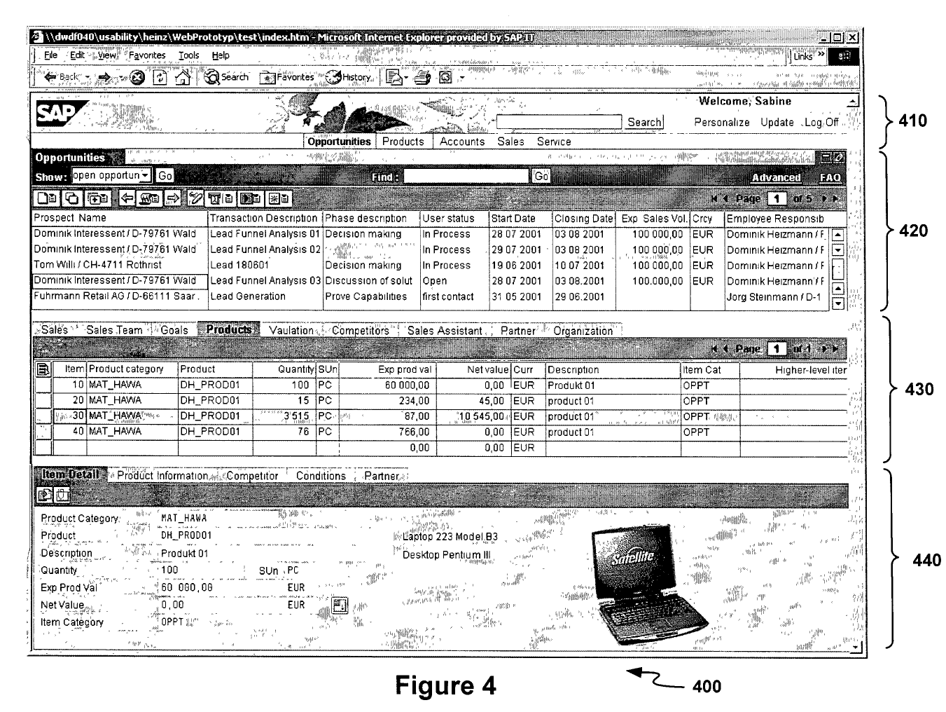

FIG. 4 shows an example of a user interface 400 with GUICs that have been specified using SCTs 110 (FIG. 1). GUIC 410 is the portal where the user can select between applications. This GUIC appears at the top of the user interface using the floor plan shown in FIG. 3. Here, the GUIC 410 was specified to offer a choice between “Opportunities,” “Products,” “Accounts,” “Sales” and “Service”. The GUIC 410 also was specified with its remaining details that appear in the figure.

GUIC 420 is an object identification container that appears beneath the portal according to the FIG. 3 floor plan. As noted earlier, four of the GCTs may be mapped to an object identification container (select, collect, orient and identify). Accordingly, the GUIC 420 was parameterized with the specifics of the corresponding SCTs, providing the object identification container's search functions, buttons and column headings, for example.

GUIC 430 is an object data container appearing beneath the object identification container according to the floor plan in FIG. 3. This GUIC 430 is the one to which the GCT “Operation” is mapped, so the GUIC 430 is configured to provide the technical mechanisms for handling the display and editing of data. Here, the object data container has been specified with the details of its SCTs, including the tab row at its top and the column headings in its body.

GUIC 440 is a second object data container appearing below the first one per the floor plan. The GUIC 440 corresponds to the GCT “Extended Operation” and has been declared to perform the functions of its SCTs. For example, the GUIC 440 has been parameterized with the tab row at its top and the fields below it. Also, the GUIC 440 was made capable of displaying an image of a selected product as shown in the figure.

In summary, the method in FIG. 1 can be used to create the user interface of FIG. 4 through the use of SCTs, GCTs and GUICs.

GCTs can be defined using existing business processes. Preferably, this involves studying existing user interfaces to determine the SCTs they encompass. When the SCTs have been identified, they may be analyzed to determine the GCTs they can be matched with. This analysis may be understood as “abstracting” the SCTs; the purpose is to determine the underlying structures, features and actions which SCTs in different business processes have in common. As an example, consider that one of the SCTs is “edit an address”. By analyzing the function of this SCT, one may decide that a more generic task—i.e. a GCT—would be “edit operational data”. Accordingly, a “reverse-engineering” process may be applied to existing business processes as part of generating new user interfaces.

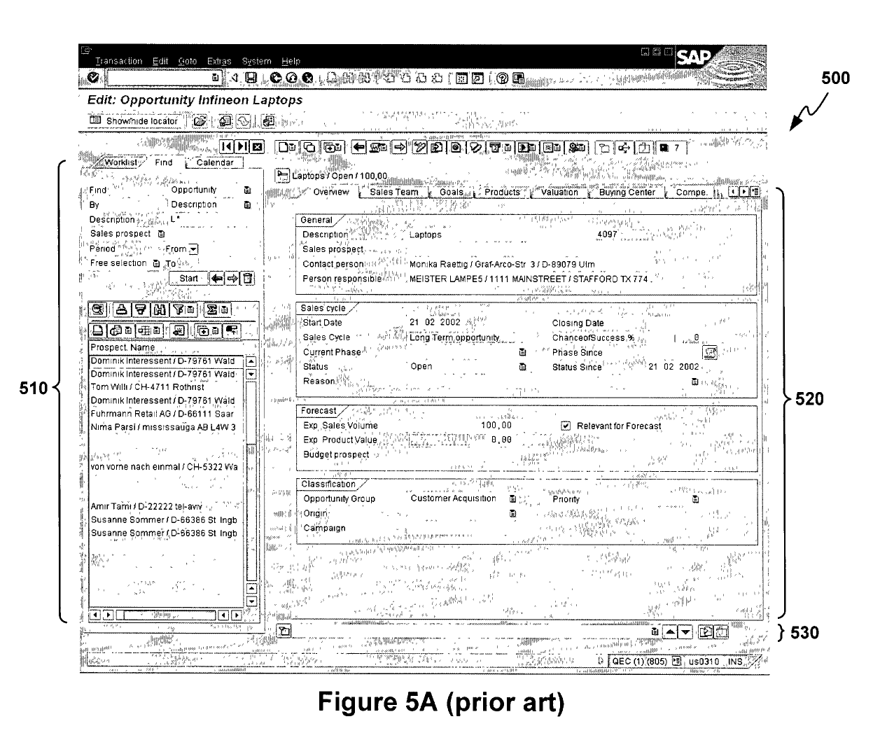

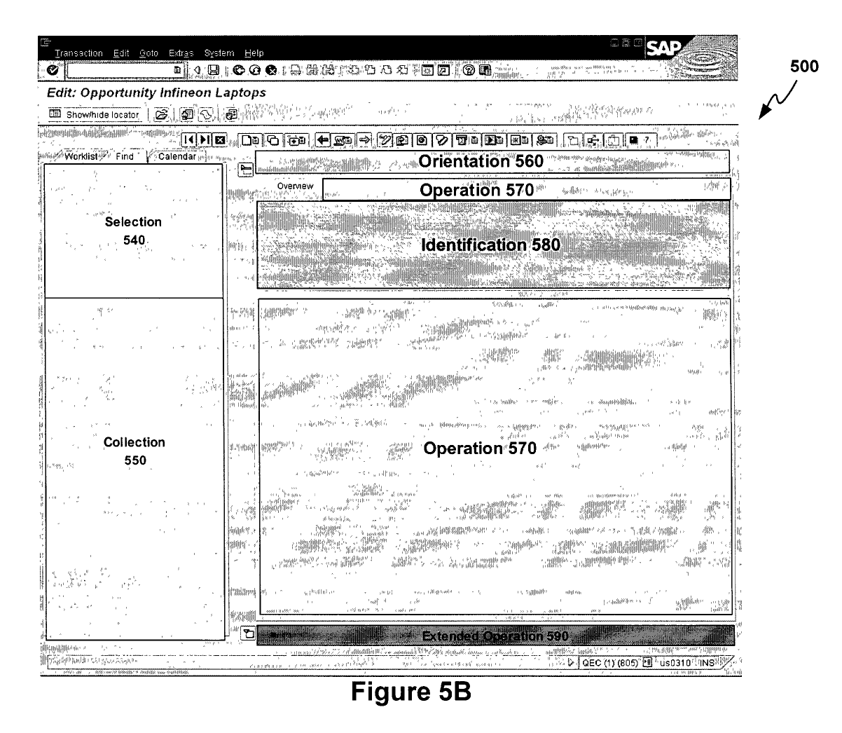

Two examples of this process will be given. FIG. 5A shows a user interface 500 for a computer application sold by SAP AG in Walldorf, Germany. The title indicates that this instance of the user interface 500 is used for managing opportunities, and that this particular “opportunity” relates to Infineon Laptops. The user interface 500 includes three general areas: a locator area 510, a main opportunity area 520, and an opportunity detail area 530. At the top of the locator area 510 the user can enter searches for a database of opportunities and have the results displayed towards the bottom. The main data of a selected opportunity in the search results are displayed in the main opportunity area 520 and can be edited there. Details of the selected opportunity can be displayed in the opportunity detail area 530 (currently empty).

As part of the reverse-engineering process, the interface 500 may be studied along the terms described above to determine its SCTs. The SCTs, in turn, may be analyzed to identify the GCTs of the user interface 500. FIG. 5B shows the floor plan of GCTs in the user interface 500. The two GCTs to the left is selection 540 and collection 550, indicating the selection of opportunity objects and the collection of search results. An orientation GCT 560 was identified at the top of the right side of the user interface 500. This is where the generic task of the user orienting herself is carried out. An operation GCT 570 is performed in two areas of the user interface 500, and this is the main area for working with the opportunity objects. An identification GCT 580, in contrast, typically is a read-only area allowing the user to identify a selected opportunity object by its basic data. An extended-operation GCT 590 displays an additional level of data about the selected opportunity object for review and editing.

After the GCTs in FIG. 5B have been identified, they may be used as part of the inventive process of developing a user interface. It may be preferable to apply the above reverse-engineering process to more than one existing user interface. This may increase the range of SCTs that are identified and lead to the identification of more flexible and versatile GCTs and GUICs. Therefore, an additional example will be described.

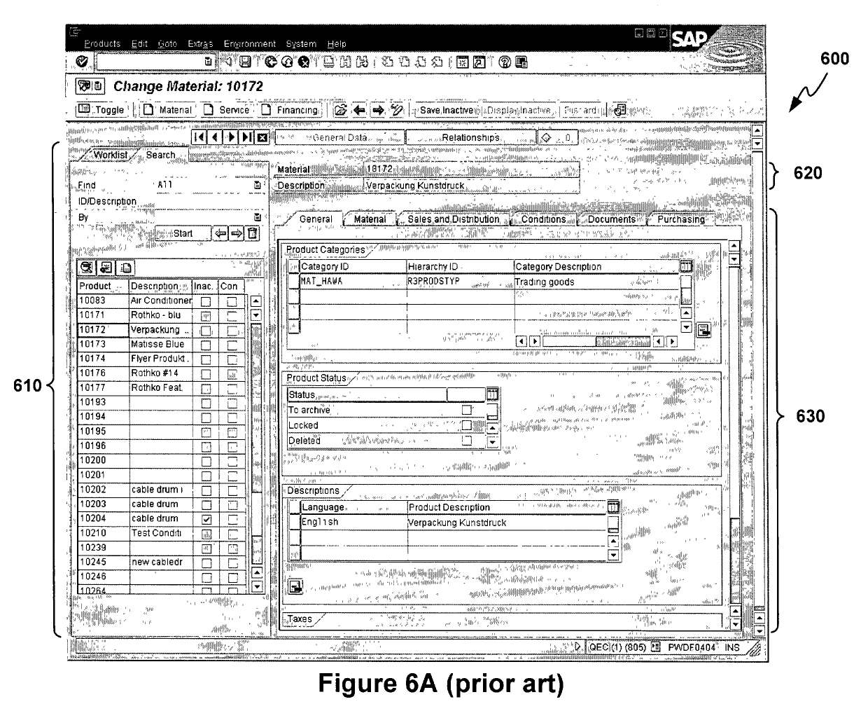

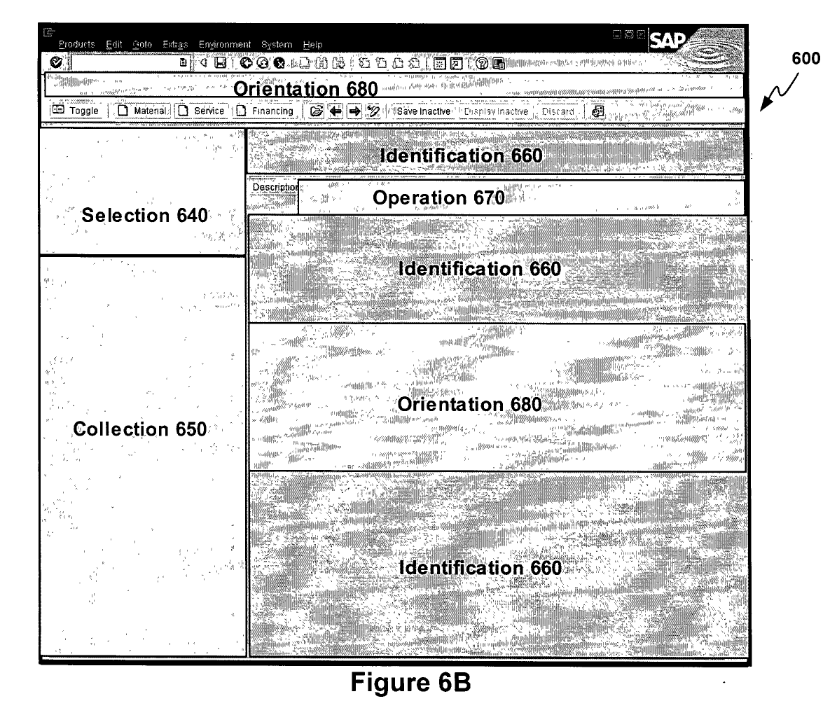

FIG. 6A shows a user interface 600 for a computer application sold by SAP AG in Walldorf, Germany. The title indicates that this instance of the user interface 500 is used for changing material, and that the selected material has number 10172. The user interface 600 includes three general areas: a locator area 610, a material information area 620, and a material data area 630. The locator area 610 can be used for searching a database and displaying the results. The material information area 620 identifies the selected material and its number. The material data area 630 displays a variety of data about the selected material.

FIG. 6B shows the floor plan of GCTs in the user interface 600. The two GCTs to the left is selection 640 and collection 650. An identification GCT 660 is performed in three areas on the right side of the user interface 600, interspersed by an operation GCT 670. The orientation GCT 680 is performed in two areas of the user interface.

It will now be described how one may proceed with the results of the above examples. It is noted that the reverse-engineering process can include many user interfaces, ranking in the numbers of thousands or more. How many, and which, existing user interfaces to include in the process may be determined depending on the intended purposes of the user interface being developed. For example, when developing user interfaces intended for computer applications in the area of customer relations management (CRM), it may be desirable to include a number of existing CRM user interfaces in the process. On the other hand, a desire to make the intended user interfaces flexible and versatile may suggest including broader categories of user interfaces in the process. For brevity, this description discusses the results of analyzing the above two examples of existing user interfaces.

The GCTs identified for the two user interfaces 500 and 600 may be compared and analyzed in a reverse-engineering process. If they have GCTs in common, this may suggest that these GCTs would be suitable candidates to be mapped into GUICs. GCTs unique to certain user interfaces may be analyzed separately. For example, analyzing such a GCT may reveal that this GCT and one or more other GCTs are part of a broader GCT that encompasses them all. It can then be considered whether to replace the former GCTs with the latter one. As other examples, it may be decided that the sole GCT should be included without modification, or that it should be omitted. This process results in the identification of GCTs that are to be included in the method of developing user interfaces.

From the GCTs, suitable GUICs will be created. This may involve a thorough analysis of the GCTs. Generally, the object is to create a GUIC that is susceptible to performing the potential SCTs that fall within the GCTs. The analysis may include determining the following information.

1. A short description of the intended GUIC;

2. Underlying problems sought to be overcome, and the task(s) necessary in doing so;

3. Context of the intended GUIC;

4. Factor(s) affecting the design of the intended GUIC, including forcing constraints;

5. Related user-interface components, e.g., those that are to be used at a greater level of detail than the intended GUIC; and

6. Where and how the intended GUIC should be used.

When a substantive example of the intended GUIC has been formed, it may also be useful to analyze the following factors.

7. Resulting context for the intended GUIC, e.g., the consequences of choosing a particular solution; and

8. Rationale, e.g., why this solution was chosen over others.

In the above example described with reference to FIG. 2, the object identification container (GUIC 245) was developed to correspond to four GCTs: selection, collection, orientation and identification. The object data container (GUIC 265 in FIG. 2) was developed for the two GCTs operation and extended operation. Different GUICs could have been used for any of the GCTs. Another example of creating a GUIC to which GCTs can be mapped will now be described.

Assume that it is desired to develop a new user interface for various tasks of collecting objects. This user interface should, for example, be capable of displaying and managing a shopping cart in an online store. Working through the items of the just-mentioned list, one may obtain the following information for a “collecting” GCT.

1. Description. Temporarily place objects selected from a product catalog in a storage area. Allow the objects to be maintained (e.g., edited, deleted), and display additional information about objects. Allow the user to resume work from the area.

2. Underlying Problems. Objects must be selected step-by-step and be bundled by the application program before any operations can be performed on the bundle. Not providing a temporary storage would place a heavy load on the working memory.

3. Context. This problem occurs when objects are collected from one or more sources which later will be used to operate on the objects.

4. Affecting Factors. The list of collected objects can become rather long, so it cannot simply be placed at a different part of the screen. Also, meta information about the collected objects is needed, such as their availability and sum total, and textual explanations about ordering.

5. Related Components. With reference to FIG. 2, the object identification container (GUIC 245) and the object data container (GUIC 265) are related components. Other related components are embedded controls such as tables, buttons, toolbars, text and hyperlinks.

6. Uses. As a shopping cart in online shops, and any application where different source objects and/or object hierarchies are used to create new structures.

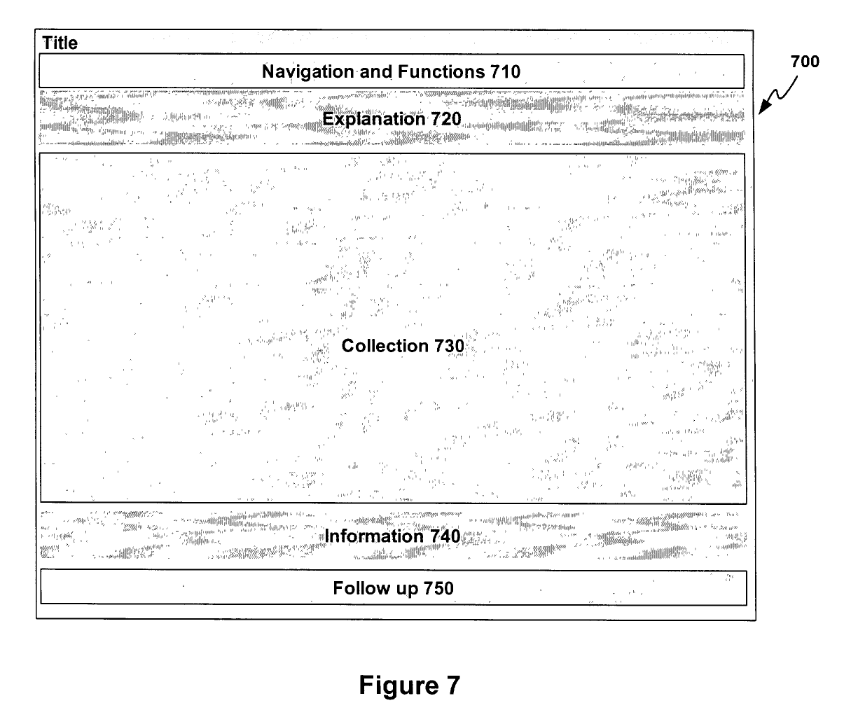

Analyzing the above information, one may develop a floor plan showing the tasks that should be possible to perform in the user interface. FIG. 7 schematically shows a floor plan 700 of a GUIC with subtasks 710-750 represented as areas of the display. The navigation and functions area 710 involves the user navigating to different views in the user interface and executing various functions. The explanation area 720 is optional and may include informing the user of the purposes and possibilities of this aspect of the user interface. The collection area 730 may contain the selected objects displayed hierarchically in a table. The information area 740 may contain information about the selected items, such as a sum total. The follow-up area 750 allows a user to initiate follow-up actions, for example by use of a wizard.

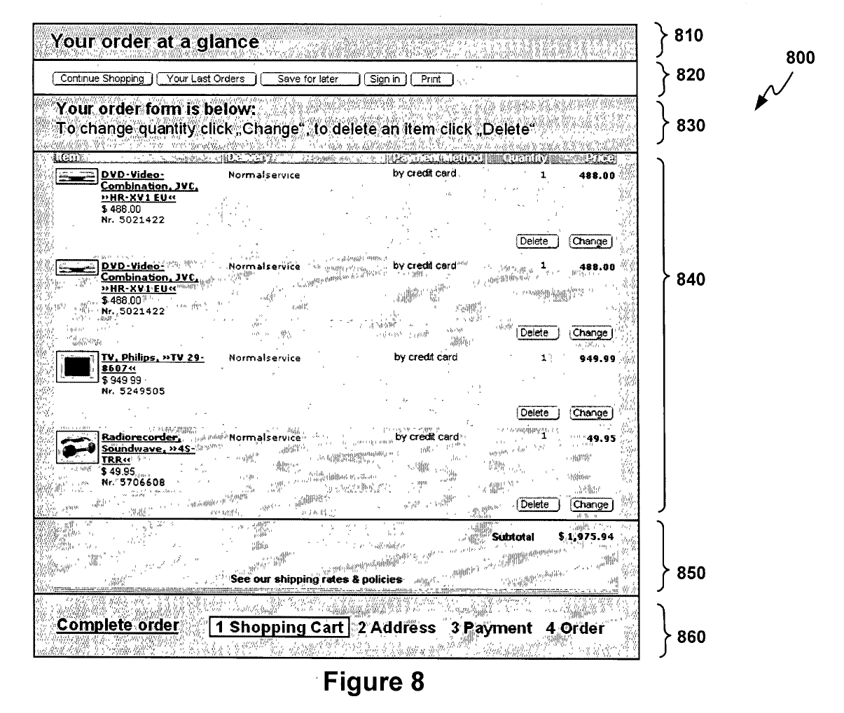

The floor plan 700 and its subtasks may be used as the basis for a GUIC to develop a user interface for the collection GCT. FIG. 8 shows an exemplary GUIC 800 which has been parameterized with specific features and functions. A title 810 informs the user about the GUIC 800. Navigation and functions subtask 710 is mapped to a row of buttons 820 with functions such as “Continue Shopping” and “Your Last Orders”. Instructional text 830 corresponds to explanation subtask 720 and explains some functions of the GUIC 800. The collection subtask 730 is mapped to object collection 840 which presently contains four objects. Information subtask 740 is mapped to informational area 850 which contains a sum total of the objects in object collection 840 and a link to another view regarding “shipping rates & policies.” The action bar 860 corresponds to the follow-up area 750 and allows the user to complete the order that is displayed in the GUIC 800; the four stages of order completion being outlined in the action bar 860 with “1 Shopping Cart” currently highlighted. Thus, GUIC 800 is an example of a generic user-interface component to which the collection GCT may be mapped.

It was described above how the method illustrated in FIG. 1 can be used to develop the user interface 400 shown in FIG. 4. Such methods may have advantages beyond the development of a first user interface as will now be described.

Once a set of GCTs have been identified and corresponding GUICs developed, they can be used repeatedly to create new user interfaces. Over time, one may create a library of GCTs and GUICs that, being prebuilt components, become very useful in user-interface design. For example, when a designer is working on creating a new user interface, she may access such a library to identify the GCTs that match the SCTs of the project at hand. The GCTs are mapped to their corresponding GUICs such that the GUIC is easily identified for every GCT. Having identified the GUICs, then, they are assembled into a suitable generic floor plan, and the user interface is at a stage where it can be parameterized with the specifics of the SCTs.

The use of GCTs and GUICs may improve efficiency while reducing the undesirable differences that may be introduced by individual designers. Sometimes, several user interfaces are created for a common project. For example, an extensive application program may require a number of designers to work independently on creating user interfaces. Another example is a company that wishes to have a common “look and feel” to user interfaces of its products over time. Creating the several user interfaces from a common set of GCTs and GUICs may improve the consistency in appearance and functionality.

A number of embodiments of the invention have been described. Nevertheless, it will be understood that various modifications may be made without departing from the spirit and scope of the invention. Accordingly, other embodiments are within the scope of the following claims.

We claim:

1. A method of developing a user interface comprising:
identifying specific tasks to be carried out by users;
matching each specific task with one among a plurality of generic tasks; and
creating a user interface by gathering generic user-interface components associated with at least one of the generic tasks and specifying each generic user-interface component using the specific tasks that are matched with the generic task with which said generic user-interface component is associated.

2. The method of claim 1, further comprising identifying the plurality of generic tasks by a reverse-engineering process.

3. The method of claim 2, wherein the reverse-engineering process includes analyzing a plurality of existing user interfaces to determine their specific tasks.

4. The method of claim 3, further comprising identifying the generic tasks from the specific tasks of the existing user interfaces.

5. The method of claim 1, wherein creating the user interface comprises assembling the generic user-interface components in a generic floor plan.

6. The method of claim 5, wherein the generic floor plan is developed for the gathered generic user-interface components.

7. The method of claim 1, wherein specifying the generic user-interface components includes declaring at least one from the group consisting of a function, a field, a label, and a table content of one of the specific tasks.

8. The method of claim 1, wherein a generic user-interface component is associated with more than one generic task.

9. The method of claim 1, further comprising identifying one of the generic tasks by abstracting a plurality of the specific tasks.

10. The method of claim 1, further comprising identifying one of the generic tasks by determining at least one from the group consisting of underlying structures, features and actions that are common among at least some of the specific tasks.

11. The method of claim 1, wherein a generic task is at least one from the group consisting of entry and monitoring, selection, collection, orientation, identification, operation, extended operation, storage/on-demand and outlet.

12. A method of developing a user interface comprising:
identifying a first plurality of specific tasks to be carried out by users;
analyzing at least one application process to determine a second plurality of specific tasks included in the application process, determining a generic task for each specific task in the second plurality and associating each generic task with a generic user-interface component;
matching each specific task in the first plurality with a generic task; and
creating a user interface by gathering the generic user-interface components associated with at least one of the generic tasks and specifying the generic user-interface components using the specific tasks.

13. The method of claim 12, further comprising analyzing a plurality of existing application processes to determine their specific tasks.

14. The method of claim 12, wherein creating the user interface comprises assembling the generic user-interface components in a generic floor plan.

15. The method of claim 12, wherein specifying the generic user-interface components includes declaring at least one from the group consisting of a function, a field, a label, and a table content of one of the specific tasks.

16. The method of claim 12, further comprising identifying one of the generic tasks by abstracting a plurality of the specific tasks.

17. The method of claim 12, wherein the generic user-interface components are pre-built components.

18. The method of claim 12, wherein a generic task is at least one from the group consisting of entry and monitoring, selection, collection, orientation, identification, operation, extended operation, storage/on-demand and outlet.
